(19) United States
(12) Patent Application Publication
(10) Pub. No.: US 2019/0276135 A1
(43) Pub. Date: Sep. 12, 2019

(54) UNCREWED AERIAL FREIGHTER(TM) SYSTEM

(71) Applicant: Jan Henri van Merkensteijn, IV, San Francisco, CA (US)

(72) Inventor: Jan Henri van Merkensteijn, IV, San Francisco, CA (US)

(21) Appl. No.: 16/273,136

(22) Filed: Feb. 11, 2019

Related U.S. Application Data
(60) Provisional application No. 62/629,028, filed on Feb. 10, 2018.
(60) Provisional application No. 62/717,764, filed on Aug. 10, 2018.

(51) Int. Cl. B64C 1/22; B64C 39/02; B64F 1/36; B64C 19/00

(52) U.S. Cl. CPC B64C 1/22; B64C 39/024; B64C 2201/128; B64C 19/00; B64F 1/36

(57) ABSTRACT

A system, method, apparatus, and software for an uncrewed aerial freighter technology is provided. The technology includes an aircraft designed to carry only cargo, and operates either remotely or autonomously. The technology includes a software system to control the flight as well as refueling, landing, takeoff, and disposing and receiving of materials and containers. The technology includes a tracking system, using blockchain technology, of the materials, aircraft, and other features.

### CROSS-REFERENCED APPLICATION(S)

This application claims priority to: U.S. Provisional Patent Application Ser. No. 62/629,028, filed on Feb. 10, 2018; and U.S. Provisional Patent Application Ser. No. 62/717,764, filed on Aug. 10, 2018, each of the aforementioned patent applications being hereby fully incorporated by reference herein in its entirety.

### FIELD OF INVENTION

The present invention relates to a system, method, apparatus, and instructions which can be implemented via a computer processor to effect a computer software program or executable software system, for providing an air freight solution.

### RELATED INFORMATION

Cargo transported via airplanes originally occurred as baggage accompanying a passenger. Later, airlines developed programs allowing for transport of screened cargo as additional matters carried by the airlines. Some airlines are dedicated to shipping only cargo via air. Each of these scenarios provide disadvantages including the need for a pressurized cabin for at least the pilot and other humans onboard and possibly certain types of cargo such as human organs. The technology and resources for providing pressurized areas in the aircraft takes essential space and real estate of the aircraft. Later technology provided for the military's unmanned aerial vehicle (UAV), commonly known as a drone, is an aircraft having no human pilot onboard. The unmanned aircraft system (UAS) includes a UAV, a ground-based controller, and a system for communication between the UAV and ground-based controller. The UAV can be controlled autonomously by computers and/or be operated manually via a remote control. UAS are not encumbered by a human on-board crew, life-support systems, and the other design-safety requirements of a manned aircraft.

Cargo being transported is tracked in a variety of ways, including via scanned barcode or airline code and unique identification number. Barcodes need light/scanner to read and transmit the data. Currently, transportation of cargo via trucks and transport of materials via air use radio frequency identification (RFID) tags. RFID tags use radio waves to transmit data to and from an electronic reader to an RFID tag. Once an RFID tagged cargo is scanned, then the RFID enabled device. An RFID tag has been found to reduce costs and speed up cargo shipment time, since the amount of time and labor to process cargo shipments is reduced. For example, a pallet of cargo has an active RFID tag associated with each piece of cargo on the pallet. The employee can look up in a database what's on that pallet without breaking out the pallet and scanning individual bar codes. Some airlines who originally decided to implement RFID technology discovered that it caused a large infrastructure cost, and so not as many systems employed such technology for airfreight. Some felt that there wasn't much difference between a bar code and an RFID tag since both are to be scanned. Accordingly, a need exists to have a less intrusive infrastructure involving RFID tags or other tracking mechanisms for shipments at piece level. Supply chain software systems provide for a software tracking system of the RFID tags and associated information. Other airfreight systems propose using Bluetooth™ enabled track and trace technology such as unit load devices (ULDs) which are said to provide real-time visibility at a lower initial cost than RFID and global positioning systems (GPS). However, again, Bluetooth™ readers would need to be available for the reading of the ULDs. For ULDs, Bluetooth™ tags are linked to an air waybill and to the serial numbers of the pallet and the ULD container.

Cargo is currently shipped on pallets—which can be wooden or metal, and contain a specific measurement of items on that pallet, so that the machinery for transporting the pallet to the aircraft, and the aircraft freight storage area can both accommodate the pallet. This does not allow for easy deviation from the size limitations of the pallet used for normal airline airfreight shipments. Accordingly, there exists a need for a more flexible in size measurements of cargo to be shipped.

The weight limitations of an aircraft are dictated in part by the initial weight of the aircraft itself, including the engine. Then, the remaining weight can be spent on the cargo, being appropriately distributed in the cargo area of the aircraft. Accordingly, there exists a need for providing a lighter option of the aircraft.

The software infrastructure or supply chain management system for cargo being shipped by air can be effected by a simple lookup database storing the barcode or RFID tag identification code along with the cargo name. Secure software systems are needed to provide for a more secure transport and storage of cargo information, so that others logging into the system cannot change the originally stored information for security purposes.

### SUMMARY

Embodiments of the present invention provide for a cost-saving, efficient, and more reliable design and technology airfreight system. Embodiments of the present invention provide for an uncrewed, i.e., no pilot or human staff physically onboard the aircraft, aircraft for transporting cargo. Embodiments of the present invention provide for an Uncrewed Aerial Freighter™ (UAF™) system, method, apparatus, and computer software instructions which can be stored in the cloud, on a storage medium, on a harddrive, on a mobile device, on a network server, or other available location. Embodiments of the present invention provide for an improvement of the available UAF™ technology in design and use of a more accessible aircraft structure for cargo and hardware system for loading cargo, as well as a secure software system for control of the UAF™ technology. Embodiments of the present invention provide for a novel airfreight system that allows efficient and secure transport of items across industries.

Further, embodiments of the present invention provide for noncombative flight options for former military combat drone pilots. Accordingly, embodiments of the present invention provide not only a novel system for use across industries, but also provide a humanitarian effort to assist in decreasing the effect of post traumatic stress disorder (PTSD) in combat drone pilots. According to studies, this type of PTSD trauma is best address by reliving and mastering the traumatic event, sometimes with use of virtual reality (VR) simulations of combat missions. However, it can be said that the traumatic act may not be overcome as it is rehashed passively via a VR simulation. Instead, embodiments of the present invention provide a hands-on real world positive system for our veteran combat drone pilots to reclaim control of a drone which no longer carries and dispenses attack weaponry, but instead carries cargo and materials, and effect a proactive, positive task of getting that cargo or materials safely from one location to another location. Embodiments of the present invention provide a possible effort to assist former combat drone pilots a method for assisting in lessening the effects of trauma and for leveraging their skills in a proactive and useful manner in industry.

Embodiments of the present invention provide for a system causing an order-of-magnitude decrease in the cost of air freight operations and freight plane production. Embodiments of the present invention provide for full automation of the system, from loading to landing. Embodiments of the present invention provide for an integration with freight modalities such as the ISO containerization standard. Embodiments of the present invention provide for one or more of: pi tail/boundary layer ingestion engine, an electric taxi system, a double cargo standard, ISO and traditional airfreight possibilities, automated/remote flight planning and scheduling, platooning and vortex surfing. Embodiments of the present invention provide for one of more of: unpressurized air frame, lift body design, “one roof” production, tiled skeleton design, small hexagonal carbon fibre subunits, 3D printed metal alloy lattice, huge weight savings (mail vs. plate armor vs skeleton), easy automation compared to current production paradigm. Embodiments of the present invention provide for one or more of the following: not quite ‘unibody’ but dramatically reduced part count and complexity, automation of heavy production, dramatically increased airframe lifespan due to unpressurized aircraft, due to negligible joint shearing due to pressurization (more flight cycles possible) (decreased flight cycle severity), fewer design constraints, and more features as described herein.

### BRIEF DESCRIPTION OF THE DRAWINGS

The embodiments described herein are for example purposes and not meant to be limiting on the present invention.

FIG. 1A shows an aircraft according to an embodiment of the present invention.

FIG. 1B shows an aircraft according to an embodiment of the present invention.

FIG. 1C shows an aircraft according to an embodiment of the present invention.

FIG. 2 shows a top-front view of an aircraft according to an embodiment of the present invention.

FIG. 3 shows a right-side view of an aircraft according to an embodiment of the present invention.

FIG. 4 shows a front-right-side view of an aircraft according to an embodiment of the present invention.

FIG. 5 shows a tiled skeleton system according to an embodiment of the present invention.

FIG. 6 shows a tiled skeleton system according to an embodiment of the present invention.

FIG. 7 shows a receiving frame according to an embodiment of the present invention.

FIG. 8 shows a receiving frame according to an embodiment of the present invention.

FIG. 9 shows a receiving frame according to an embodiment of the present invention.

FIG. 10 shows a receiving frame according to an embodiment of the present invention.

FIG. 11 shows a receiving frame according to an embodiment of the present invention.

FIG. 12 shows a receiving frame according to an embodiment of the present invention.

FIG. 13 shows an ecosystem chain according to an embodiment of the present invention.

FIG. 14 shows a tokenization chain according to an embodiment of the present invention.

FIG. 15 shows an authentication chain according to an embodiment of the present invention.

FIG. 16 shows a loading system according to an embodiment of the present invention.

FIG. 17 shows a cargo loading system according to an embodiment of the present invention.

FIG. 18 shows a cargo loading system according to an embodiment of the present invention.

FIG. 19 shows a cargo loading system from a side view according to an embodiment of the present invention.

FIG. 20 shows an aircraft with landing gear down according to an embodiment of the present invention.

FIG. 21 shows an aircraft landing according to an embodiment of the present invention.

FIG. 22 shows an aircraft with cargo doors open according to an embodiment of the present invention.

### DETAILED DESCRIPTION

The below detailed description of various embodiments of the present invention are meant to serve as example embodiments and do not preclude obvious or equivalent features to one or more of those identified herein.

In embodiments of the present invention, the present system provides a mobile app or application program or set of instructions which are executable by a processor or computer (referred to herein as “mobile app” or “app” for ease of reading even if the app is used on a desktop or a non-mobile processor). In embodiments of the present invention, the present system provides a webservice or API(s). The webservice communicates between the mobile app and the external database or third party through the webservice's API (application programming interface).

In embodiments of the present invention, the present system provides a database. The web service communicates the calls from the mobile app via an API to the database. Information from the database is sent via the webservice's API to the mobile app. In embodiments of the present invention, the present system provides a web administrator system. In an embodiment, the web administrator system communicates directly with the database. In an embodiment, the web administrator system communicates via the webservice's API with the database. In an embodiment, the web administrator system communicates via a different webservice's API with the database. In embodiments of the present invention, third parties such as a payment processing center, a location-based services vendor, an administrative agency, and/or an external database/server, communicate with the mobile app and/or the web administrator system through one or more API and/or one or more webservices.

Embodiments of the Uncrewed Aerial Freighter™ (UAF™) technology is a missing-link in the current global freight infrastructure. By building the several past decades of development and innovation in military UAVs and adapting them for the civilian markets, this paradigm shift in airfreight can be undertaken according embodiments of the present invention. The current cargo paradigm insists on two classes of freight, high and low priority, which respectively travel on plane and boat. As it is untenable to raise the speed and price of shipping dramatically, it is therefore necessary to decrease the price of airfreight and open it up to the majority world that is currently left without access. Such technology of the present invention can provide for collective global development that neglected localities, the landlocked, the sea-locked, the infrastructureless, and the developing can all be included in the global economy in an efficient and cost-saving manner.

Considerations.

Embodiments of the present invention of the UAF™ technology have several features. Embodiments of this system are devoid of most human-occupancy restrictions, as it is a system meant to be operated remotely by manual control and/or autonomously via a computer processor. In an embodiment, the UAF™ aircraft is windowless. This means that less material reinforcement and consideration is needed compared to the weakness and complexity that a requirement for windows creates. Additionally, in an embodiment, the UAF™ airframe is entirely unpressurized (though the specific loaded container can still be pressurized).

This unpressurized nature is relevant to both longevity of the airframe and general reduced complexity. The lack of pressurization instances at the beginning and end of each flight cycle reduces the overall strain experienced at joints, fastenings, bolts, rivets, among others. By remaining unpressurized, the airframe also is reduced in complexity and the door to different material selection and construction methodology is opened.

Sensors.

In addition to the uncrewed benefits, certain considerations ensure the plane is able to navigate and move completely uncrewed. While a sensor suite including radar, GPS, altimeter, barometer, wind direction/wind speed, and temperature are standard for any airframe, additional considerations such as cameras suited for computer vision algorithms, LIDAR, depth sensors, etc. can also be utilized alone or in combination with each other in embodiments.

Landing Gear and Wheels.

On top of the uncrewed sensor requirements, additional considerations are provided by embodiments of the present invention. For example, the wasteful practice of using the main engines for taxi to and from the runway expends an average 25% of total fuel in a given flight cycle. This tremendous waste of fuel is the result of the high inefficiency of running engines at low and near-idle speeds. For instance, while a huff does pushback the plane from the gate and guides the plane to the gate in return, this only occurs due to the danger of operating turbofans near the terminal and around ground vehicles and crews. For example, an Israeli company, Taxibot, is attempting to create fully autonomous huffs that will guide planes all the way to the runway. While this resolves the expensive fuel problem of the plane, it does not solve the problem to the fullest extent possible. While jetfuel is highly expensive, operation of a huff is too. Not only can they cost upwards of multiple millions of dollars for specialized planes such as the A380, they require specialized maintenance and storage.

By instead looking to the automotive industry and adopting the wheel-mounted electric motor, the plane can conduct its own pushbacks, taxiings, and parkings, and in essence become its own huff. This taxiing system will herein be referred to also as the Electric Taxi™ System (ETS).

In an embodiment, the UAF™ technology utilizes an electric taxi system (ETS). Rather than the current model employed in the cargo world today, wherein a huff attaches to the aircraft for pushback and taxiing, the aircraft of the present invention will conduct its own pushback and taxi. While this is no miracle of aviation, this process will be conducted entirely without engine power, instead running off of on-board batteries. The reason for this change is simple; jetfuel is one of the most significant operational costs and the taxi-takeoff/landing-taxi process accounts for well over 25% of the fuel consumption of any given modern flight cycle.

In an embodiment, the ETS is comprised of the high capacity hot-swappable batteries mentioned above, wheel mounted electric engines, and power generation leads from the turbines and dedicated solar panels. These wheel mounted engines may be developed in house or upcycled from an electric car.

In an embodiment, the ETS overcomes the need for costly additional infrastructure as is required in the current huff-dependent model and the hydrogen fuel cell model.

In addition to the ETS, the landing gear is customized for embodiments of the present invention. In order to ensure veracity and as an added safety step, the aircraft needs to be able to evaluate its own freight and corroborate that data with the shipper, customs, and/or others—whether automatic (communication with computer terminal operating autonomously) or manual (communication with a computer and/or a person). In an embodiment, it is necessary to know the total weight of freight as a factor in fuel efficiency, max takeoff weight, and as a datapoint for the company. In order to accomplish this internal knowledge, each of the three landing gears (one fore, two aft) are fitted with a pressure sensor that measures the compression or extension of a spring or hydraulic.

In an embodiment, the tires on the landing gear need to be extremely robust. While typical airplane tires can be robust, the UAF™ aircraft needs to have tires that are specially crafted for the specific operating environment, be it dirt/sand, tarmac, or snow, anticipated.

Cargo Environment.

In embodiments, the cargo environment of the airframe provides for, at the center of the airframe, a cavity spacious enough to accommodate a 40 ft ISO container or two 20 ft ISO containers, for example. Other measurements can be allowed, provided consideration of weight and size is resolved. In an embodiment, the floor is fitted with twist locks (e.g., such as the standard locking mechanism for any ISO container). In an embodiment, these points on the floor are configured to be retractable so that breakbulk and other cargo modalities can also be accommodated. This is useful because the structure provides a more modular cargo environment, flexible depending upon the type and size of cargo. In an embodiment, the interior floor of the aircraft can utilize rollers to ease the movement of pallets and smaller containers. Such rollers can be in tracks to facilitate movement in predefined paths. Such rollers can be in less defined paths and be multidirectional in their rolling to allow for a more modular and flexible moving and placement of containers/pallets/materials.

In an embodiment, at the back of the cargo hold, a ramp is provided that exits to the aft of the aircraft. In an embodiment, this ramp is designed for cargo movement and can be covered in industry-standard rollers. In an embodiment, the ramp can double as a lift gate (per the back of a delivery truck). In an embodiment, in order to accomplish this elevator motion, four hydraulic points, instead of two as can be seen on the C130, for example, can be used. The forward two can be left fixed while the rear two extend to form a ramp. All four can be used in unison to utilize the rear as a lift gate.

In an embodiment, above the cargo hold, the roof is sealed by bay doors. In an embodiment, the bay doors can be embodied as two long doors running in parallel, or four smaller doors. In a different embodiment, the bay doors are replaced by a rolling metal screen on tracks. All points of connection can be encouraged magnetically or by another available method. In an embodiment, it is not necessary that these bay doors or metal screen form an airtight seal over the bay.

In-Flight Refueling (IFR).

The UAF™ technology is a multi-role platform. In this sense, one UAF™ aircraft can be used to conduct in-air-fueling of another UAF™ aircraft by replacing its standard ISO container with a specialized liquid cylinder ISO (International Organization for Standardization)-compatible container that is full of fuel. In an embodiment, this fuel tank is connected to the proper fuel lines within the cargo bay. In an embodiment, each UAF™ aircraft has one line out through the rear bottom and one line in through the front top. In an embodiment, two UAF™ aircrafts conducting in-fight refueling continually ping one another till they are close enough to engage, at which point computer vision analyzes a camera feed from the extended fuel boom and guide it incrementally into the receiving point on the receiving UAF™ aircraft. Before connection and during the moment of connection, nitrogen as a neutral element must be pumped through the line to avoid any sparks. The nitrogen can be stored in easily replaceable (hot-swappable) tanks at the rear of the cargo environment. After a secure connection is verified, fuel can be transferred from the leading UAF™ aircraft to the tailing UAF™ aircraft.

There are several modes of IFR, including a central drop line hose and drogue system (slack line), a rigid boom system, an underwing pod drop line (slack line), and other less typical configurations. In an embodiment, the dominant mode chosen for the UAF™ technology is the central drop line. Each UAF™ aircraft has a retractable central drop line in the rear belly and a rigid boom in the upper nose. This allows, for example, for a special reflexive characteristic when operating in a group of greater that two, the IRF Daisychain. The technique assists in the swarm dynamics of the UAF™ aircraft as it will allow for the fleet to share fuel. With the Eco Chain in place, the settling of fuel sharing accounts can be immediate and simple.

In an embodiment, the IFR system connecting to the UAF™ aircraft's fuel tanks, can also interface with the cargo bay via special hose connections. In an embodiment, these are connectable to ISO liquid carrying containers that are loaded into the cargo bay and attached/interfaced with the receiving frame. This will turn that specific UAF™ aircraft into a more dedicated tanker style role, which helps when serving transoceanic and transcontinental swarms.

In an embodiment, the IFR system provides nitrogen that pumps through the system to ensure that no oxygen is present to catch fire should any sparks occur during contact of the drogue and male boom. The pumping of nitrogen through the system is critical and unavoidable, however carrying and supplying nitrogen in tanks would be very supply chain intensive. Fortunately, in an embodiment, the UAF™ aircraft conducts in-situ utilization (ISU) of nitrogen (N2) and produce its own to meet IFR safety standards. ISU can be made easy with N2 from an airplane as the air is mainly constituted of it, even at higher altitudes with a thinning atmosphere. Air may be taken into the UAF™ aircraft via classical open hole air intakes or via permeable membranes on the belly of the UAF™ aircraft. In an embodiment, the N2 is purified, concentrated, and stored in tanks as either N2 (gas) or LN2 (Liquid).

Flight Computer.

In an embodiment, in the front of the cargo bay, in the void within the nose of the plane, all essential flight control systems including the flight computer, air-to-ground communication systems, and air-to-air communication systems can be situated. In an embodiment, rather than rely on the physical mechanisms of pulleys and hydraulics, the UAF™ aircraft is a fly by wire system, meaning it conveys control commands via wire and electric signal. In an embodiment, it is highly important that the UAF™ aircraft be able to operate in a swarm or fleet dynamic and with high tolerances for close proximity group operations, thus, it is therefore necessary to have highly accurate transponder signals between the fleet members.

General Construction.

In an embodiment, the UAF™ aircraft has a metal and composite based airframe. While the internals and support structure, including the internal frame of the airframe, are made of metal (such as one or more of: aluminum, titanium, and other specialized alloys), the surface skin and lifting body of the aircraft are primarily carbon fiber. In an embodiment, the carbon fiber composition of the aircraft's skin allows for a greatly reduced overall weight of the airframe compared to a purely metal construction methodology. In an embodiment, the UAF™ aircraft has an atypical engine positioning and therefore an atypical wing design. While most modern jetliners tend to position their engines below the wing to reduce cabin vibration and noise (and therein increase passenger comfort), there is some precedent for rear mounted engines. See, for example, the McDonnell Douglas DC-10 and French Sud Aviation Caravelle (1955). In an embodiment of the present invention, placing engines at the very rear of the airframe creates several benefits. First, for example, when the plane is cutting through the fluid of the air, at the very rear of the plane is a pocket of slow-moving dead-air that pulls the tail down and greatly reduces lift. By immediately filling this spot with fast moving air from the engines, huge gains in fuel efficiency occur. Second, for example, by placing engines away from the wings, the wings can be engineered for the exclusive purpose of lift. And third, for example, placing engines to the rear of the airframe helps distribute weight on an otherwise forward heavy airframe.

In an embodiment, in terms of control surfaces, the UAF™ aircraft utilizes elevons, a rudder, and differential thrusting. More specifically, each wing will have two or more elevon sections as is typical in any modern plane. It will also have a rudder on its tail for a typical flight control schema. In an embodiment, differential thrusting of the port and starboard engines will be available for use.

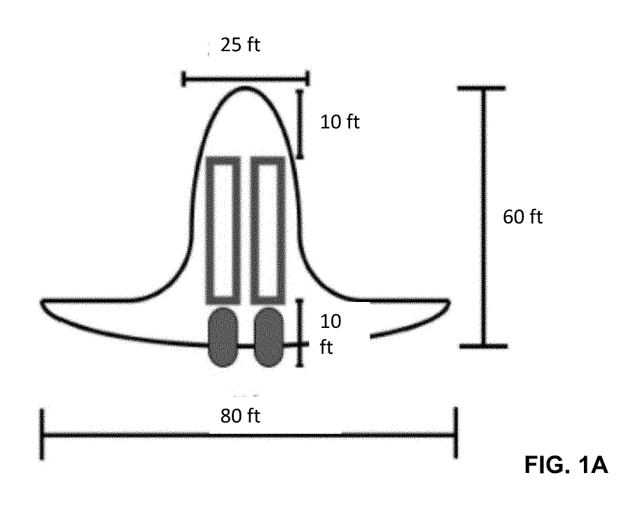

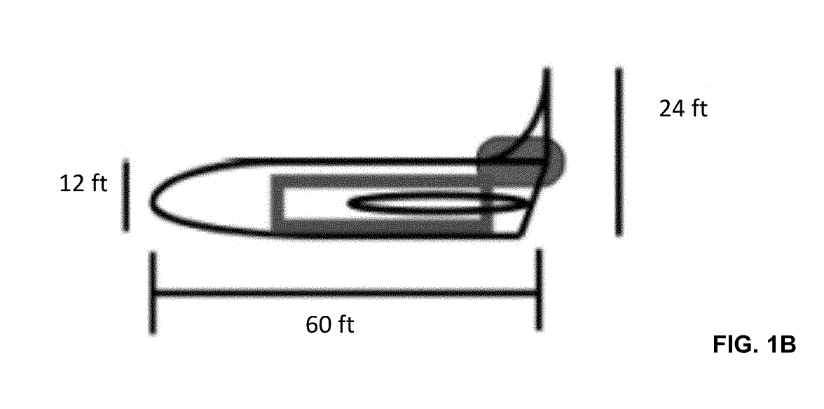

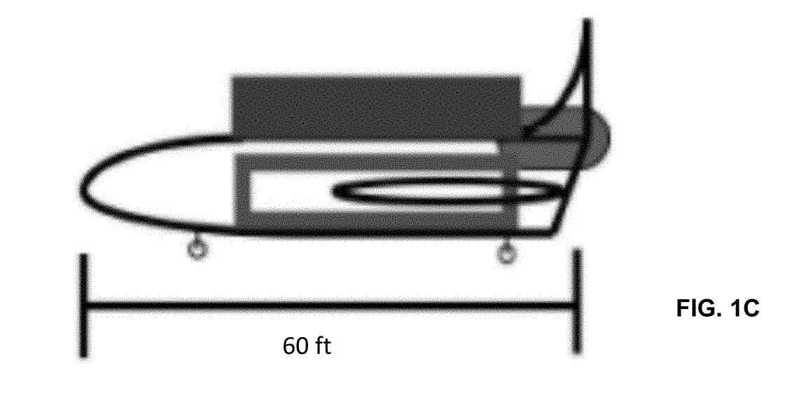

In FIGS. 1A, 1B, and 1C, an example aircraft is shown. In FIG. 1A, two containers are shown located in the center of the aircraft. The multiple engines are shown in the back of the aircraft. This allows for a distribution of weight that can be advantageous for the aircraft. In FIG. 1B, example dimensions of an aircraft are shown. The location of a container(s) in the body of the aircraft is shown, along with placement of one or more engines. This example shows the aircraft in flight, with the landing gear inside the aircraft, and the cargo doors closed on the aircraft. In FIG. 1C, an example aircraft is shown with the cargo doors opened. For example, the cargo doors are located on the top of the aircraft, as opposed to the side or back of the aircraft. An example embodiment of a UAF™ aircraft is as follows:

Specifications:

Length 60 ft|18.25 m

Wingspan 110 ft′ 33.5 m

Height 20 ft|6.1 m

Empty Weight (OEW) 20,000 lb|9,000 kg

Cargo Weight 2 TEU|120,000 lb|55,000 kg

Maximum Takeoff Weight (MTOW) 200,000 lb|90,000 kg

Cargo Hold Volume 2560 ft³|72 m³

Powerplant Two Turbofan Engines

Range 6000 Miles

Maximum Fuel Vol 6340 gal|10000 L

Maximum Fuel Weight 60,000 lb|27,000 kg

Uncrewed: Piloted|Overseen|Autonomous

Swarm Dynamics: Tethering|Vortex Surfing

IFR|IFR Daisychain

Legacy and ISO 20′ and 40′ compatibility

Electric Taxi System (ETS)

Rear Mounted Engines|Thrust Vectoring

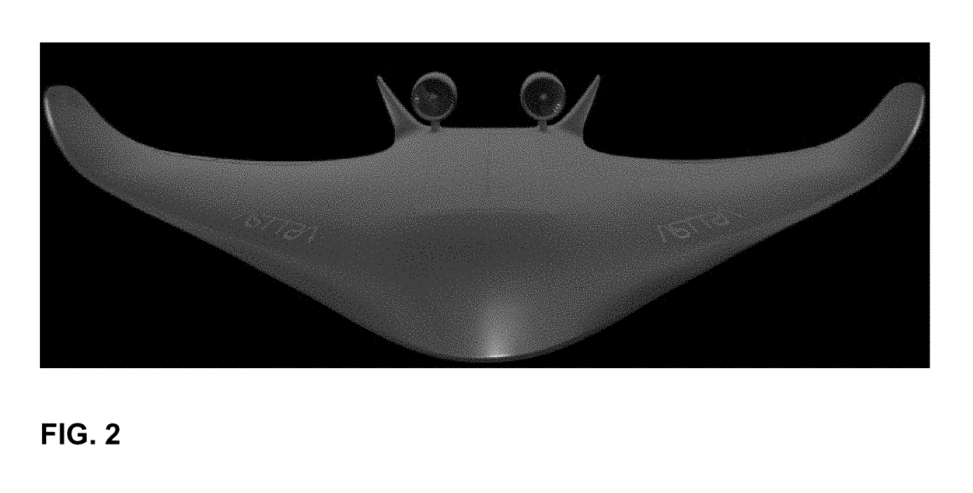

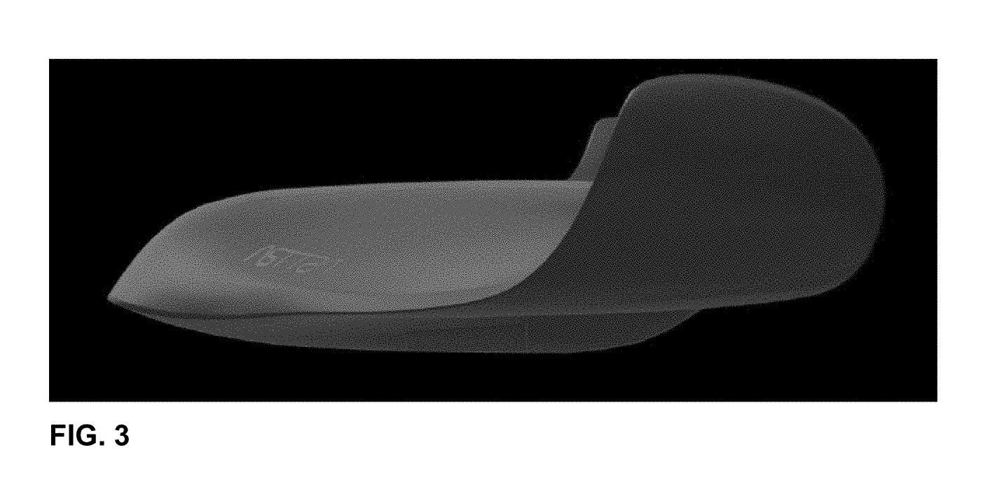

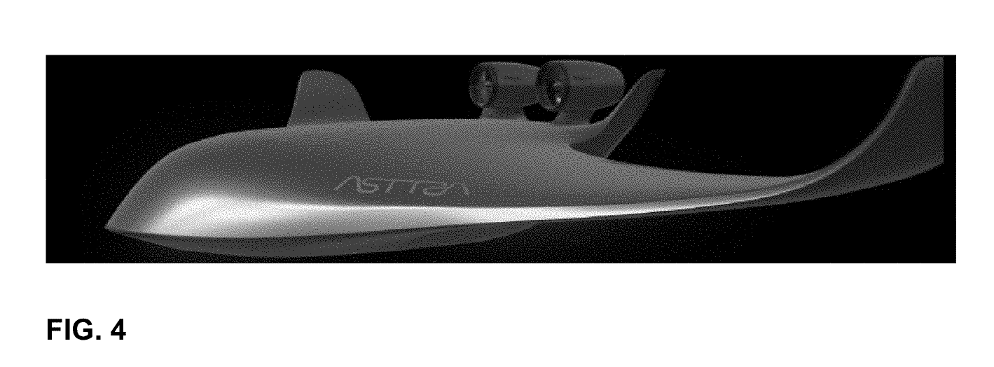

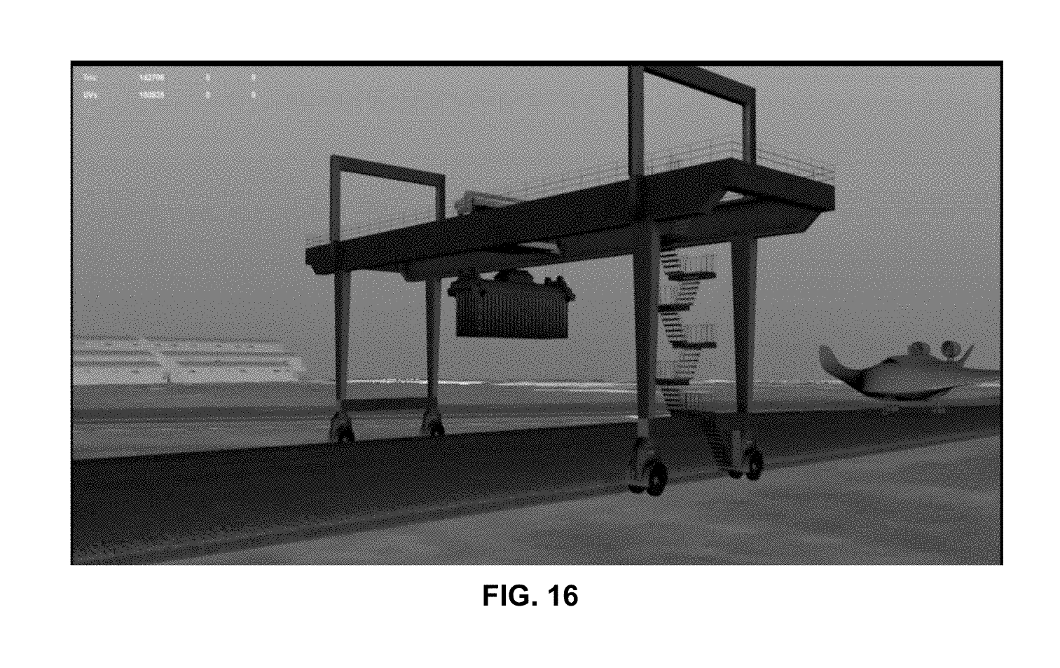

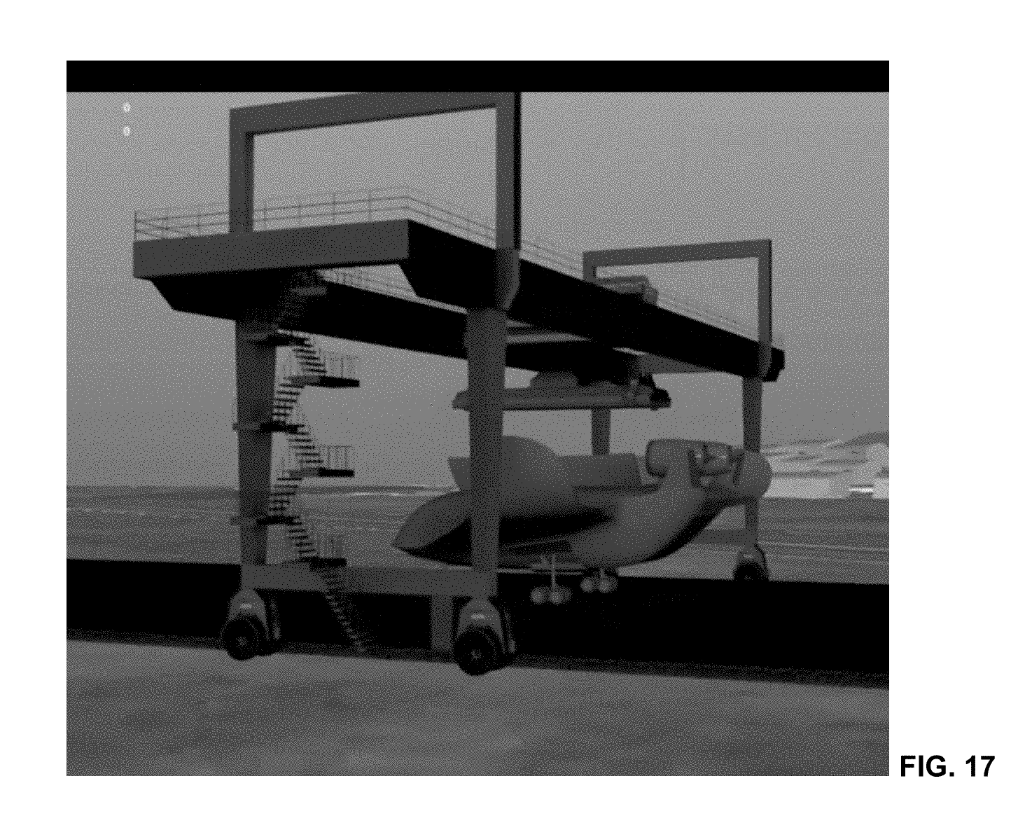

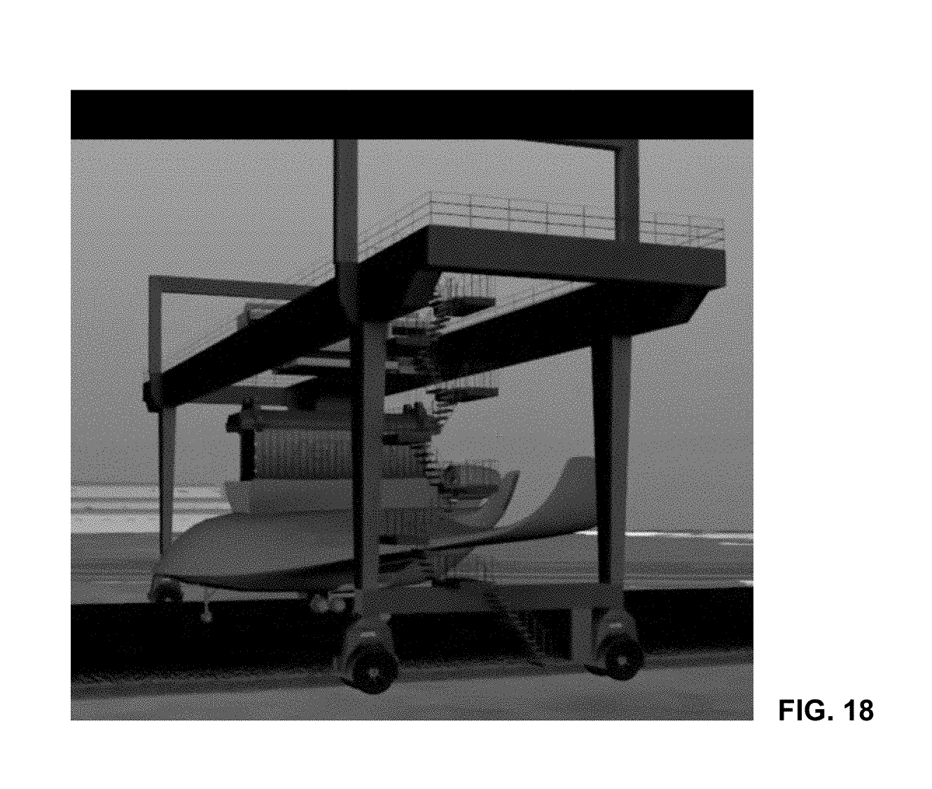

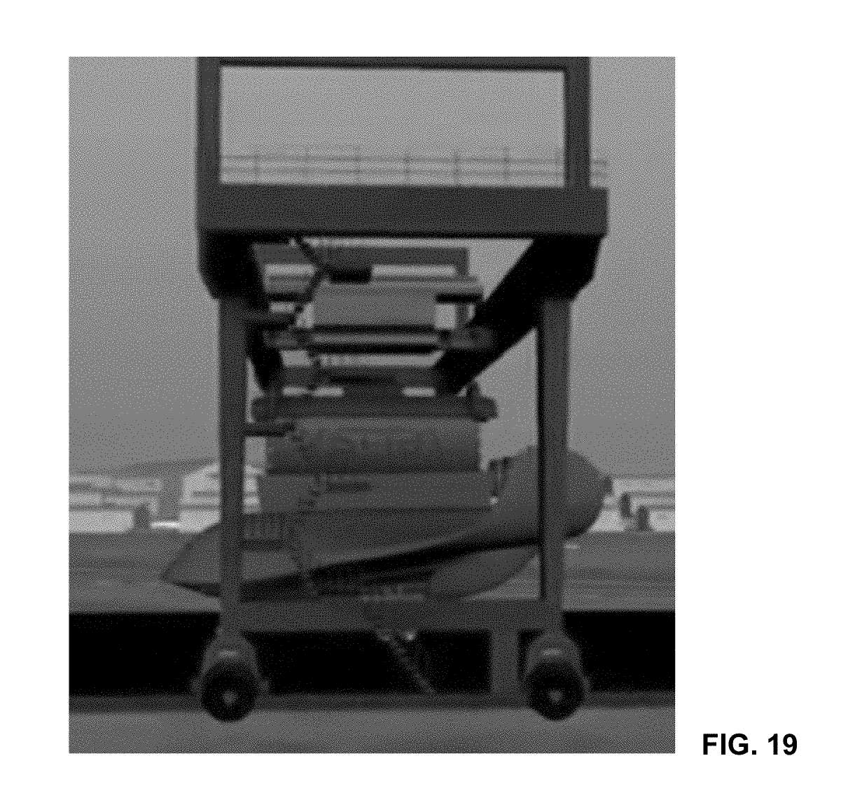

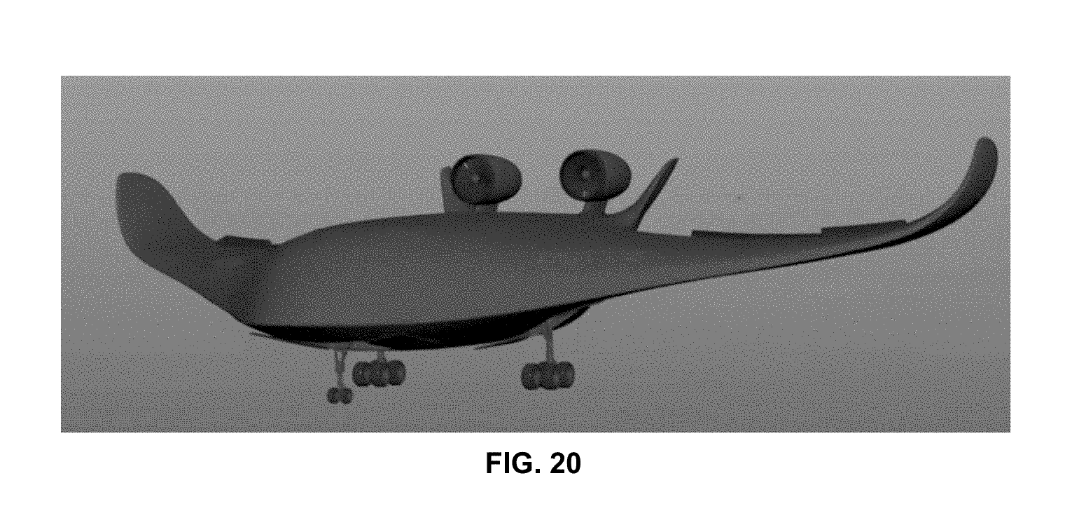

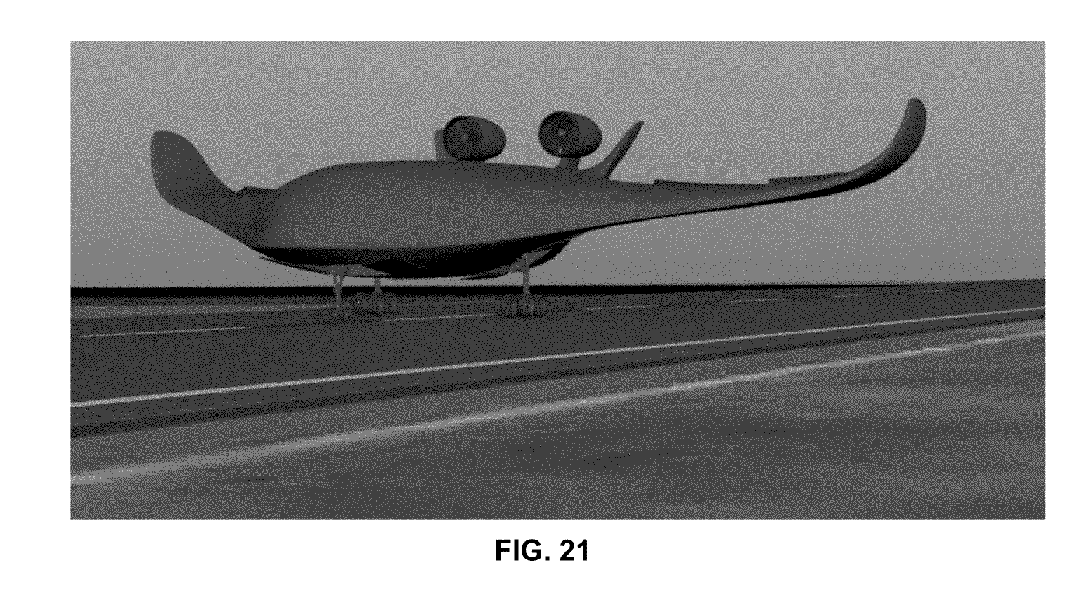

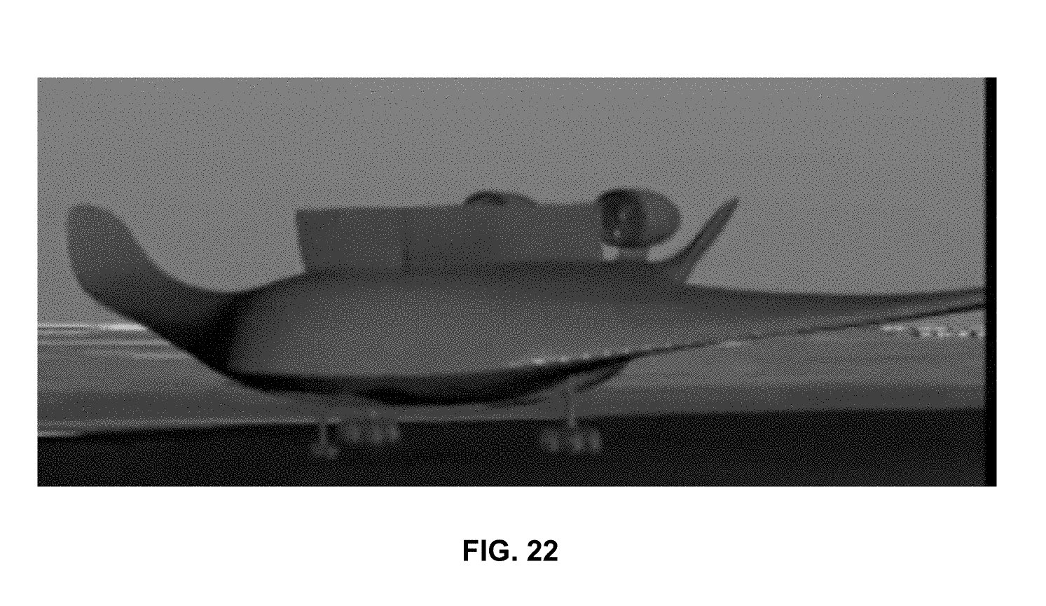

In the various Figures, such as FIGS. 16 to 19, an embodiment of the aircraft is shown as a structure with a top-loading structure having a container for loading or unloading from the aircraft. In an embodiment, the container is suspended either from removing from an UAF™ aircraft or for depositing into the top portion of the aircraft. Note,” in embodiments of the present invention is being used interchangeably with “UAF™ aircraft.” Other Figures, such as FIGS. 2 to 4 and 20 to 22, show different perspectives, including top and side views of the aircraft aerodynamic structure, which includes a consideration for the load weight of any container or cargo to be carried as well as the placement of the engine of the aircraft.

For a showing of the following embodiments of the loading device, bots, and ground control embodiments, please refer to FIGS. 16 to 19.

Loading Device.

The loading and unloading of the container into and out of the UAF™ aircraft is a key procedure. The UAF™ loading ecosystem is very simple to develop and implement as it is similar to the extant global shipping industry systems. The UAF™ system is compatible with many container cranes including gantry style cranes, rubber tire gantry cranes, and straddle carriers. Additionally, less traditional transfer devices such as forklifts, boom lifts with spreaders, reach stackers, and container handlers may be utilized.

Service Bot.

In an embodiment, the UAF™ Service Bot is a dedicated ground service vehicle that shadows the plane. The Service Bot is able to conduct many of the operations currently carried out by human ground staff today. These processes include refueling, visual inspection of the airframe for damage (using computer vision and AI (artificial intelligence)), brake inspection, engine fluid cycling, tire pressure monitoring, tire air refilling, recharging batteries, deicing the plane in cold weather, and cleaning the plane for general maintenance.

Container Handling Bots.

In an embodiment, once a container has been lifted from the cargo bay and the receiving frame by the container handling device (crane or lift), it is then loaded onto an autonomous handling bot as are beginning to be utilized in major global container handling facilities like the Port of Hamburg or the Port of Rotterdam

Ground Control Container.

In an embodiment, each UAF™ aircraft, when being operated in remote by a human rather than fully autonomously, requires a command space of less than 20×8 feet, the same footprint as the smaller ISO standard shipping containers. This means that the UAF™ aircraft can carry and relocate multiple remote control ground stations. These stations commune with the UAF™ aircraft via direct local bands and satellite Ku bands. While initially piloting will be in 1:1 pilot to airframe, eventually the pilot will transition into more of an overseer role as technology progresses and will manage a swarm of several UAF™ aircrafts singlehandedly.

Software.

In addition to the hardware, software is a facet of the UAS™ technology. In order to gain boosts to fuel efficiency, UAF™ aircraft can operate in fleets or swarms. Like cyclists riding in a peloton, drafting behind trucks, or geese flying in V-formation, there is efficiency in cutting through a fluid, such as air, in formation. For airplanes, lift is a necessary measure of movement and efficiency. In order to gain additional free lift, planes can organize in a V-formation much like how geese conduct themselves for long distance flight. In addition to the V shape, planes must stagger themselves slightly vertically from the planes in front of them. This process, called vortex surfing, allows the lead plane to pass some of the lift generated on its wingtips to the planes behind it, therein creating huge efficiency gains. The tolerances for how close the airframes must be in formation are very tight, and therefore extremely accurate and precise flight software is needed.

While vortex surfing is beneficial to all the planes in a given fleet, the planes share the benefits differently. The lead plane takes on the brunt of the inefficiency, with subsequent planes gaining increasing amounts of efficiency the further back in the V they are. In order to compensate for this asymmetrical distribution of efficiency, a sharing economy can be put into place. Based off of the internal loads, distance traveled, and calculations of vortex surfing efficiency gains, it is possible to allocate some compensation to the lead plane for the efficiency gains given to his following fleet. This sharing economy can be used for any multi-operator fleet of UAF™ aircraft.

In addition to the software needed for fleet dynamics, a system of software can also be used on the logistics side to increase efficiency dramatically. In an embodiment, by creating a blockchain ledger system to track every element that enters the cargo bay (via an RFID (radio frequency identification) gate in the plane and RFID tag on the package/container), huge gains in efficiency and trust can be made. While the blockchain tracking of packages will aid in extremely quick customs clearance and preclearance, it can also allow for the sharing economy needed to enable vortex surfing dynamics. Additionally, the blockchain tracking of freight can allow for the near-real-time search of their location, a feature currently unavailable to consumers wishing to track a package. The secureness of blockchain systems allows for use and storage of this information in a confidential or secure manner. Currently, the consumer can only see instances of transition in a package's delivery cycle (for example, “Package Arrived in Memphis 1/2/2000”) but cannot see its location enroute. It is therefore possible to pair this blockchain tracking with a GPS ping (that updates, for example, at fixed intervals of 5 minutes or so, or other time periods, or even semi-fixed intervals, or even in essentially real-time, etc.).

Production.

In an embodiment of the present invention, the production methodology behind the UAF™ technology aids in minimizing the overall cost per airframe. In certain embodiments, heavy reliance on automated processes, robotics, and AI will be used in order to minimize the number of humans needed in the production process and within the physical production environment. While specialized technicians can be utilized to keep the machinery operational, almost all part production and assembly will be conducted using an automated assembly process.

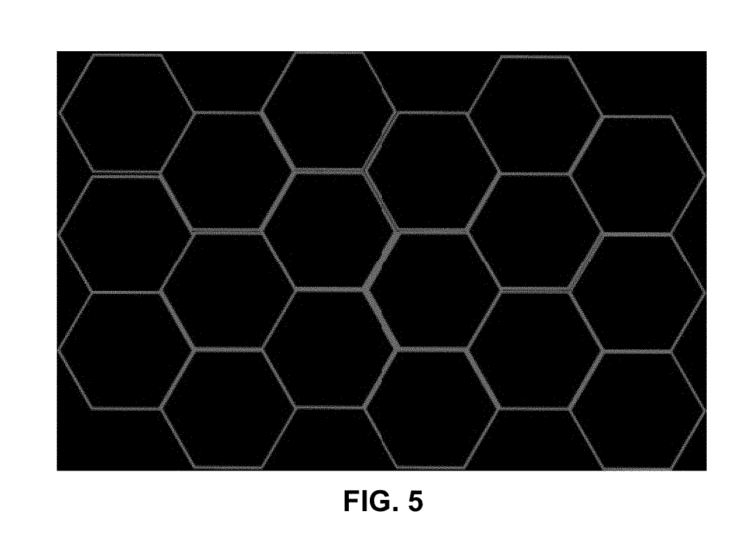

In order to aid in the ease of production and longevity of use, a novel airframe solution has been created. In an embodiment, the UAF™ aircraft is constructed utilizing a tiled skeleton technology approach. This tiled skeleton (TS) comprises two main constituent parts, the skeleton and the tiles, as shown in FIG. 5.

In an embodiment, the skeleton is one of or a combination of a rigid metal or alloy frame that exists at all the major seams, joints, and leading edges of the airframe. In embodiments, the skeleton is cast, 3D (three-dimensionally) printed, or additively manufactured utilizing aluminum, titanium, alloys, or other suitable materials or combination of such thereof. While the skeleton includes all structurally integral parts of the airframe, wherever there is a lift surface, the skeleton is not to be utilized and instead will have a negative space for a tile. Each of these negative spaces in the lattice of the skeleton is hexagonal and can fit one tile element. Each of these negative spaces in the skeleton can be flat or curved and contoured to the airframe's needs.

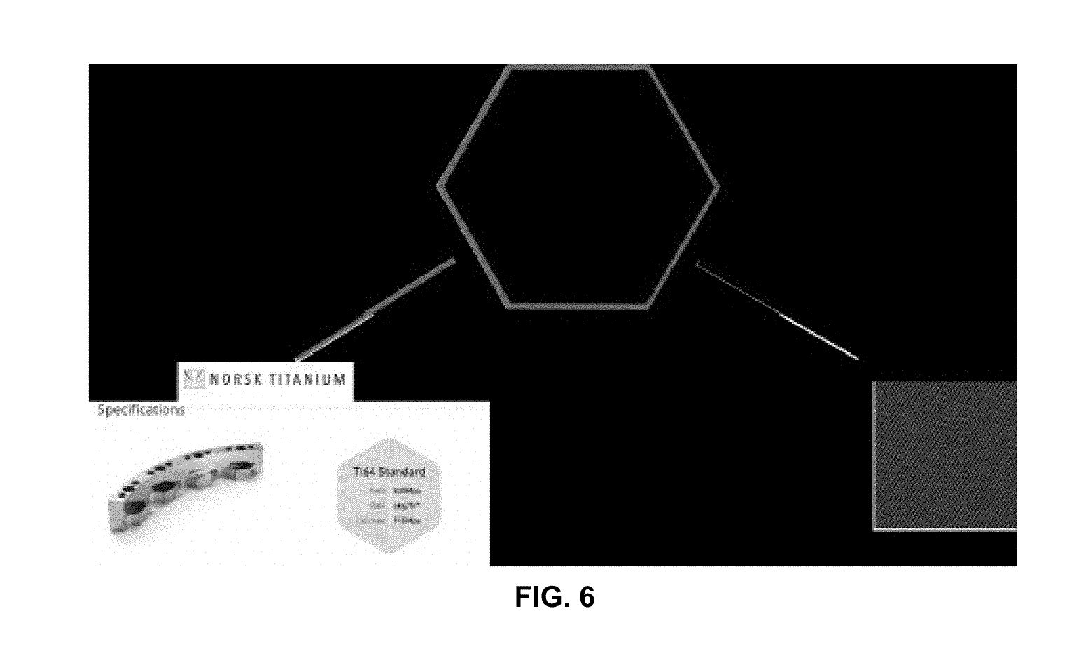

FIG. 6 shows an example embodiment. The tiles for this airframe are carbon fiber composites. Each tile is a hexagon of multilayered carbon fiber. In an embodiment, these tiles are comprised of many layers of stacked carbon fiber, not just one sheet. In an embodiment of the tiled skeleton, six sheets of carbon fiber comprise each tile. In this embodiment, the top carbon fiber sheet is oriented 0,° the next is oriented 60° to the left, the next sheet is oriented another 60°, and the process is repeated six times until all carbon fiber sheets are oriented toward a different direction and constitute a different face of the hexagonal tile.

In an embodiment, the connection of a tile to the skeleton can be accomplished in several different ways or embodiments. In an embodiment, tiles are fastened using a single or multi-part epoxy, adhesive, or glue. In another embodiment, the Tiles are fastened using a more typical rivet or nut and bolt system. Finally, in yet another embodiment, the tiles are secured to the skeleton using friction and force via a metal, ceramic, or other insert piece/s. In each of these embodiments, the skeleton's negative space has a lip on which the tile may rest. In an embodiment, this lip is narrow, but enough to keep the tile from falling through the negative space of the skeleton. The lip is the point to which the tile would also be attached by utilizing one of the various embodiments above.

Some benefits of tiled skeleton include that the skeleton can be 3D printed in large subunits, reduced complexity, and slotting of tiles into the skeleton is straightforward to automate.

In an embodiment, the tiled skeleton or “Tessellated Tiled Skeleton” (TTS) is an example production approach to the UAF™ aircraft. This technique requires taking the surface of the UAF™ aircraft and breaking it up into perfectly interlocking equilateral hexagons. These hexagons are allocated over the entirety of the surface, and when a hexagon doesn't have room to be complete on the edge of the surface area, rather than warp, it terminates. The hexagons are outlined by the skeleton part of the TTS which is an additively manufactured matrix with negative space for hexagonal tiles. In an embodiment, while the UAF has a metal skeleton, its tiles are comprised of carbon composites. In an embodiment, these composite hexagons are held to the skeleton using one or more of bolts, fastenings, and/or aerospace adhesives.

In an embodiment, each tile is a layered sandwich of woven carbon composite sheets. Each layer of the hexagon tile will be oriented 120 degrees from the layer below it. The first layer is rotated 120, the second layer is rotated 240 degrees, therein giving full coverage of the different fiber orientations from the weave. This triple rotated layering is then mirrored again to create a tile with a total of six layers. In an embodiment, this process can be expanded upon to produce thicker tiles as well.

In an embodiment, while many tiles will be flat, some of the TTS design employs curvature of the tiles.

In an embodiment, for the skeleton, while single hexagonal skeletons can be printed individually and later joined, sometimes subassemblies of several hexagonal skeletons will be employed. In an embodiment, this is predominantly as a means of ensuring the whole supply chain is containerized itself.

Embodiments of the present invention provide for an uncrewed aerial aircraft and system. Previous systems, such as the Global Hawk, can be reutilized and refurbished to fit the specifications of an embodiment of the present invention.

Receiving Frame.

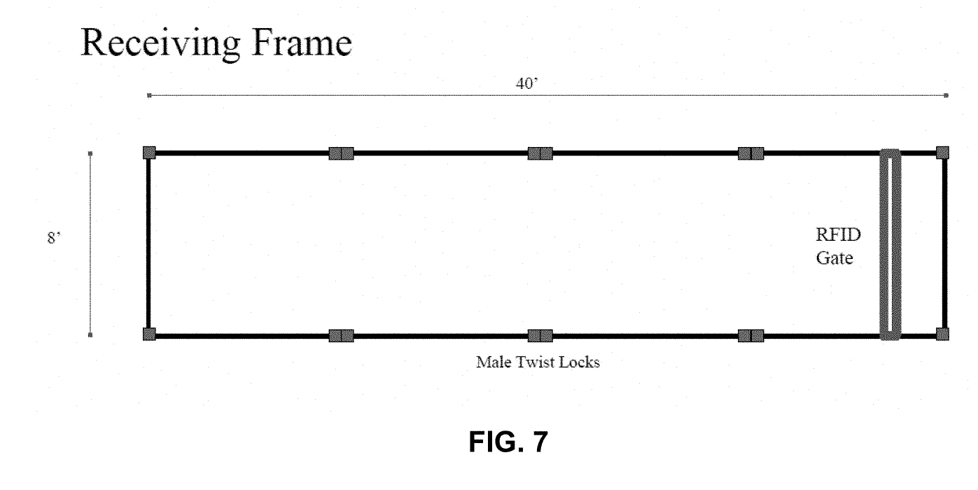

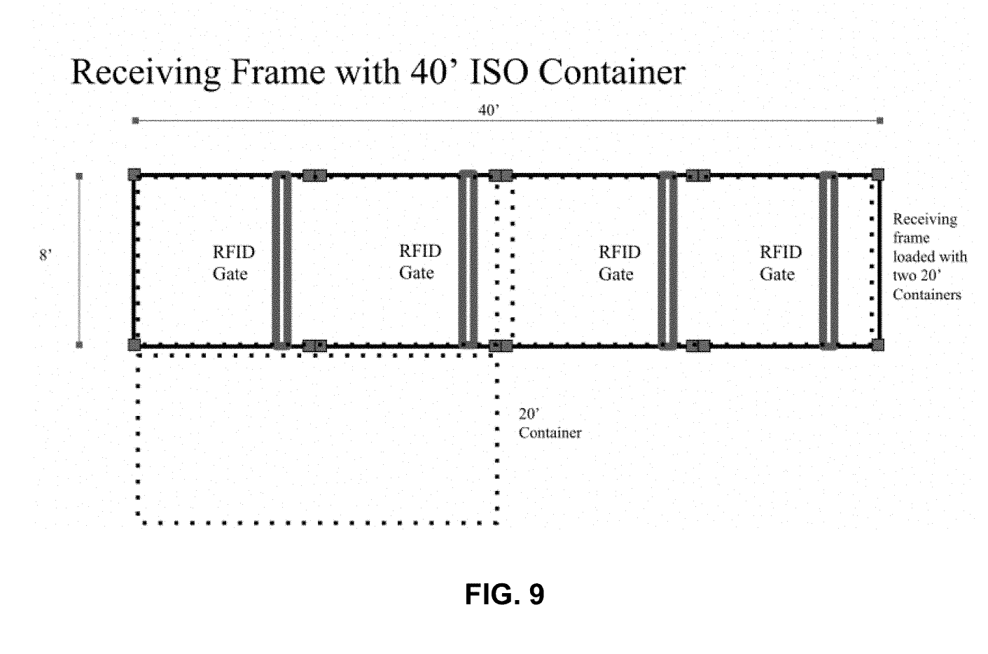

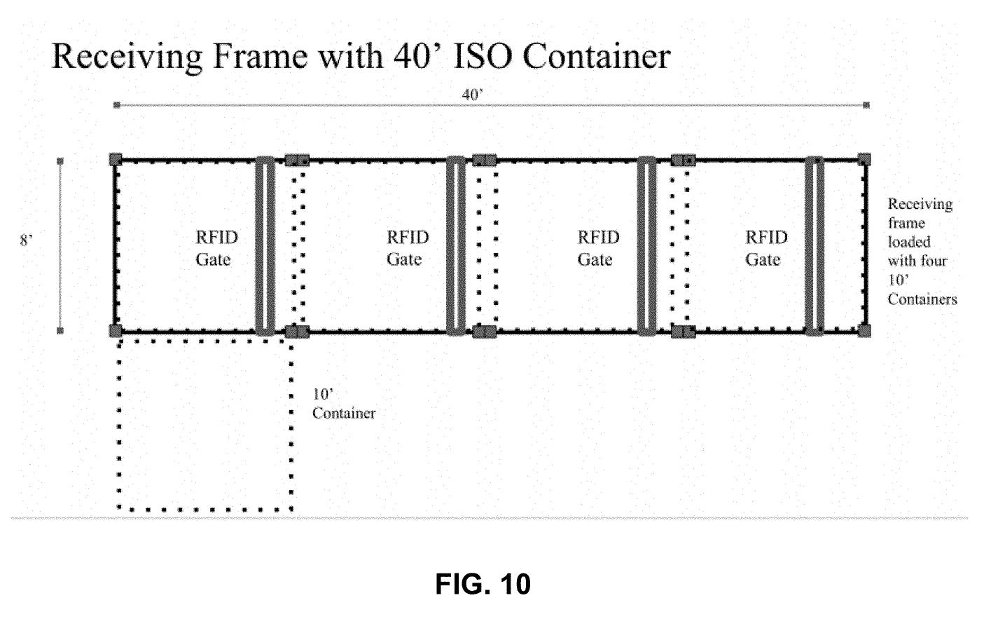

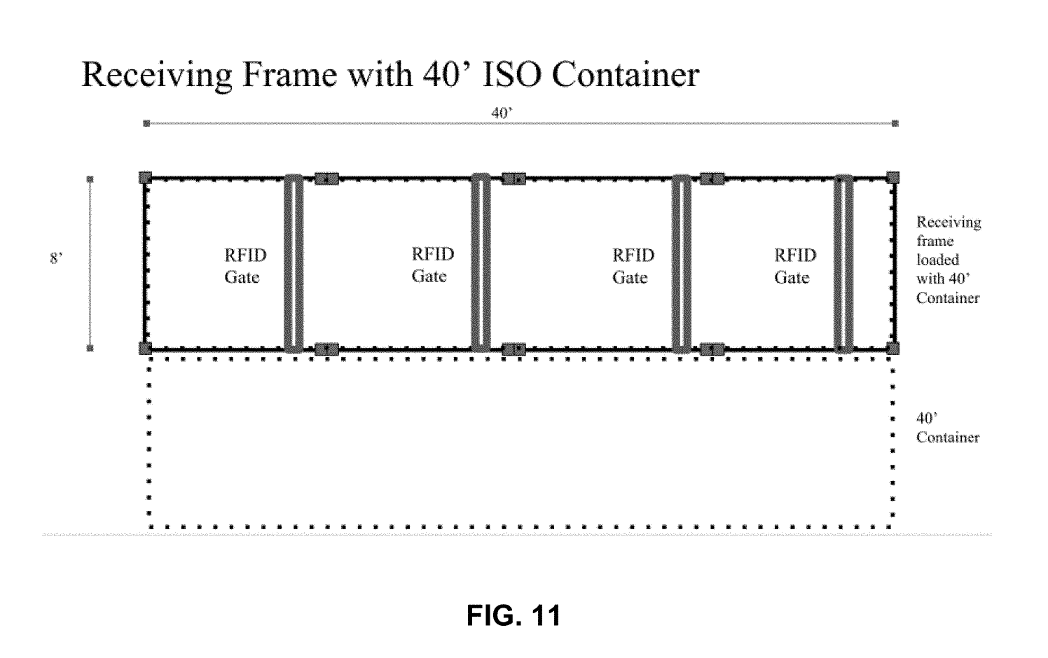

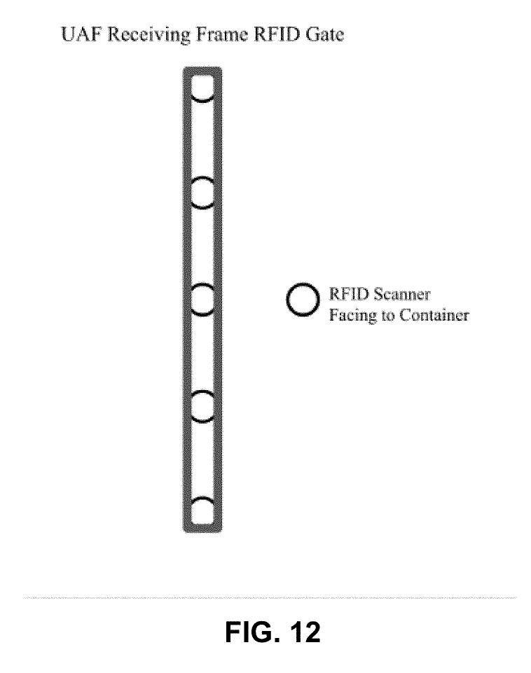

FIGS. 7 to 12 show various examples of the receiving frame, in which one or more containers can be placed. FIG. 12 specifically shows example placement of RFIDs for tracking purposes. In embodiments of the present invention, the receiving frame (RF) serves a dual role as interface between the UAF™ technology and the container physically, but also between the container and the UAF™ technology digital infrastructure, in particular, the parallel blockchains. In an embodiment, the receiving frame interfaces and interacts with the intermodal shipping container using the standard male twist lock mechanism. This is used to secure the container from above, below, and/or the sides to the physical cargo bay of the UAF™ aircraft. For example, the successful physical interfacing is concurrent to and is registered in the digital presence of the aircraft as well. In an embodiment, upon docking, the standard ISO container is logged indelibly into the three blockchains (eco, auth, and token) via a confirmation of an RFID contact on the container and the receiving frame RFID Gate. The RFID is pinged periodically during the transportation of the container, and these pings are also recorded and available for observation by interested parties. In this way, rather than only being able to track cargo in transit down to the city or delivery hub, it is now possible for the average consumer to view their goods with a granularity of seconds due to this recurring RFID handshake at the receiving frame and its imprint on the relevant parts of the three blockchains.

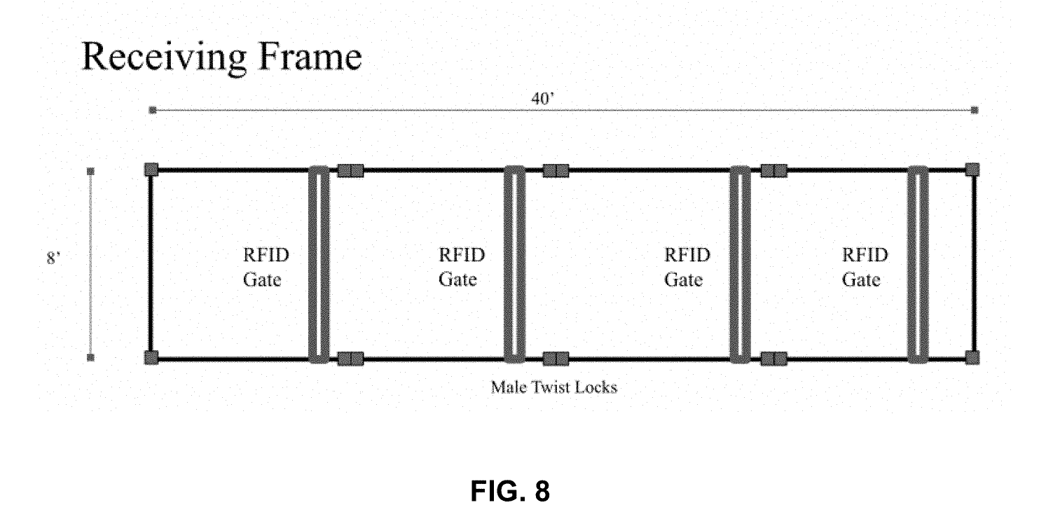

In an embodiment, structurally, the receiving frame is rectangular and of the same proportions as the standard ISO shipping container, that is to say 40′ long by 8′ wide. It is traditionally utilized under the container, but can instead or also be implemented above or on the sides for additional security should the cargo require additional fragility considerations. The receiving frame, as shown in FIG. 7, has male twists locks positioned to handle one ISO 40′ container, or two 20′ ISO containers, or four 10′ ISO containers (16 total male twist locks) (see, e.g., FIGS. 8 to 11). In embodiments, special receiving frame configurations may also be implemented to accommodate less typical container configurations such as high cube (for a side mounted receiving frame) or 53′.

In an embodiment, the male twist locks have a special functionality in that they are able to be retracted into the UAF™ cargobay floor. In an embodiment, covers then conceal the retracted twistlocks such that the cargobay can be used as a breakbulk cargo space.

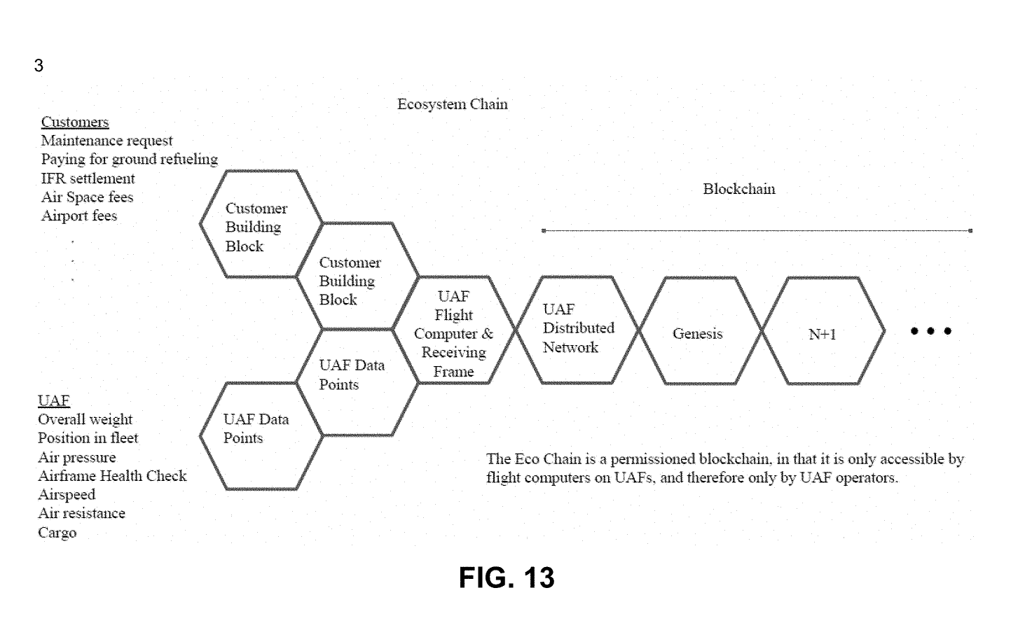

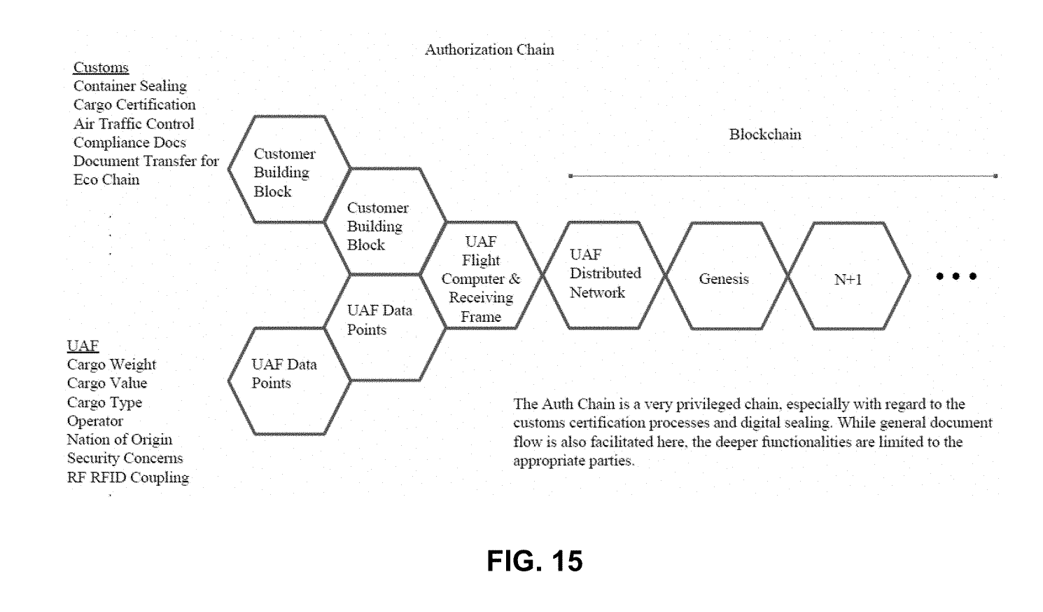

In an embodiment, some data fingerprints of the container-receiving frame interaction include its continual registration on the Eco blockchain as shown in FIG. 13. This chain is principally concerned with matters of account and therefore cares about certain container characteristics such as weight, contents (insurance), weight distribution (impact on performance, needed for ensuring fair accounting during a dynamic swarm like vortex surfing), as well as other characteristics. For the Auth Chain, as shown in FIG. 15, the focus is ensuring the cargo and container are certified, saying openly what they are carrying, and saying it often. The digital seal will first supplement and eventually replace the physical sealing process conducted today and regulated by ISO 17712. In the case of the United States, this process will certainly help with CBP's Container Security Initiative by leaving a proper papertrail for not just the current trip, but every trip a container makes in its lifecycle.

In an embodiment, there needs to be a recertification of the system and materials on a tracked schedule. In an embodiment, solar panels situation on top of the aircraft can allow for a CPU or processor reboot automatically, even without fuel powering the reboot.

Ecosystem Chain.

FIG. 13 shows an example blockchain utilized in the operation of the Uncrewed Aerial Freighter™ system (UAF), i.e., the Ecosystem Chain (Eco Chain, Eco). This blockchain has a currency style token issued on it that is credited to user accounts for their internal use in the ecosystem of products and services offered as well as for settling external accounts. Some of the main utilizations of this internal ecosystem blockchain include settling accounts during dynamic swarming activities like Vortex Surfing, paying for maintenance and refueling, paying government entities for air transit fees, and paying corporate partners for services like airport parking slips.

In an embodiment, for cargo services, the currency will be usable on an internal matching protocol for airfreight providers and senders. The pairing system is agnostic to any government issued currencies, which avoids some of the most critical issues in international commerce with regard to converting currencies during transnational shipping. In addition to the matching protocol, layers built on top will handle logistical payments to corporations and governments alike. Importantly, the plane's cargo can be broken down and sold as either a Full Container Load (FCL) or in Less than Container Load (LCL) subunits.

In an embodiment, with regard to the currency as a means of settling third party accounts in a multi-user swarm, there are many critical considerations at hand. The internal settlement system will allocate funds from the users in the swarm who receive a benefit to those who provide it. In particular, in a peloton or vortex surfing scenario, the lead member cuts through the turbulent air and creates a space of calm air that follows. It is this calmer air that the following planes take advantage of and consequently gain a performance boost from. Therein, a settlement mechanism should take into account features of the swarm like vehicle position, relative turbulence, overall weight, fuel weight, cargo weight, and distance traveled in swarm. Additionally, as the UAF™ technology can perform a daisy chain IFR, the internal settlement mechanism can also be a means of sourcing additional fuel from swarm mates.

In an embodiment, the UAF™ system is a hybrid of hardware and software in harmony. In an embodiment, a nexus of this hybrid is the interface between the two forms, the UAF™ aircraft flight computer. This flight computer is, for example, a Noded Flight Computer. Each flight computer which is used in its classical aviation capacity is also operable as a node in the Ecosystem Chain. By making the nodes of the network flight computers, the distributed network takes on the new form of the mobile distributed network. This adds an additional layer of physical security as it is far more difficult to conduct an attack against the entire network if it is physically spread out across the globe and never in the same locations twice. In an embodiment, to override the ledger and take control, the entire network would need to be absconded with. This in turn means that if one plane remains in unadulterated, the legacy correct blockchain persists. The network is also more immune to local and domestic economic turbulence in any given nation. In an embodiment, because the Noded Flight Computer is useful to the function of the blockchains, the physical and digital security measures must be strong. Respectively, in an embodiment, the physical security is effected using cryptographic identification services such as those provided by Dust Identity. In short, this is accomplished by adhering a layer of diamond dust to the sensitive component, in this case the flight computer, and measuring it with a proprietary laser. This information is then secured and is referenceable against the Dust Identity blockchain. In an embodiment, the digital security of the Noded Flight Computer is provided by a silicon identification service also secured in a blockchain. By running an algorithm and measuring its variability of output, a fingerprint can be generated for any silicon chip. These fingerprints can be a datapoint in every block and serve as a handshake of the vehicle's supposed authenticity. This certification via silicon and diamond is meant to create, e.g., a certified Gold Box on board each UAF aircraft that can be verified both physically and digitally. The Gold Box also has wallet functionality for the local storage of currencies.

In an embodiment, consensus for this network is generated every 5 seconds using each plane's satellite network Ku band uplink. The Ku band spectrum is ideal for high data transfer rates and bandwidths. In particular the network will operate between 12-18 GHz at 2.5-1.67 cm wavelength. In addition to the main fleet, several additional nodes will be operated by the company as emergency backups. Additionally, UAF aircraft operating in a swarm state will be able to affirm local consensus for various states (like turbulence level, pressure, etc) via a local network dynamic. This may utilize other K bands or C bands.

In an embodiment, while proof of work is not essential for access here, it is necessary to regulate access to the blockchain by ensuring the use of the fleet by others. This will require others to do a proof of work act on a regular basis. An example of this would be solving an SHA 256 hashing problem by conducting a flight cycle which registers all the necessary events in a chain.

The actual constitution of the blocks in the chain is critical as the data transmitted to the privileged peer network is invaluable. Some of the specifics of the blocks include, for example:

What is in each Block?
Each Block includes for example:

### Timestamp (How to Timestamp a Digital Document)

Location—GPS derived

### Altitude—Altimeter

### Pressure—Barometer

Cargo Type—Need a naming system for ×12 ish types of ISO cargo. 10 ft 10 ft HC 10 ft HC Refer 10 ft Refer, liquids . . . 53 ft HC Refer

### Temp—Thermometer

Swarm/Vortex Surfing Status—leader, second row, central, etc
Fuel status—tank gages
IFR status—capable or no

### Cargo Weight

Aircraft Version/Generation Number (might impact overall weight and therefore sharing economy)
Silicon ID verification output (run algo each block)
Flight Computer component list

### Engine Type

### Engine Maintenance Record

### Overall Weight

### Takeoff Weight

Est Landing Weight @arrival

### Cargo Explosive Status

HAZMAT Status—GHS for Chemical shipments

### Nitrogen Status

When are blocks generated, e.g.:

Once every 5 seconds

Event driven blocks, e.g.:

Flight Precertification

Container/Cargo Loading

Fueling Complete

Takeoff

At Altitude

Halfway Mark Sanity Check

Landing

Unloading

Standard blocks have all the normal inclusions while event driven blocks will contain additional specific layers and data points.

Tokenization Chain.

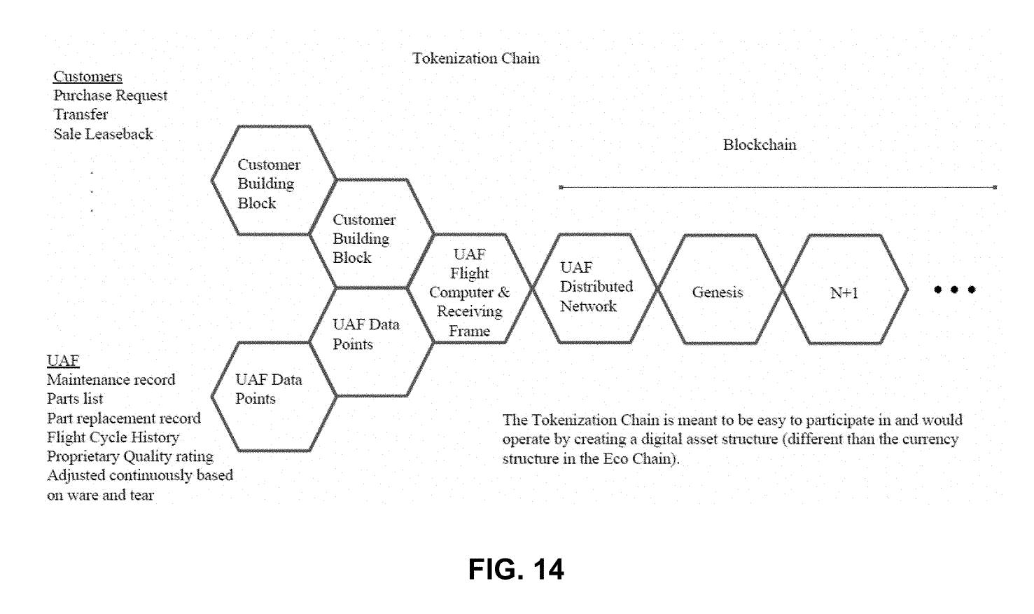

In an embodiment, the second blockchain, e.g., shown in FIG. 14, employed in the UAF™ system has to do with its structuring as an asset. A contribution made by aviation finance has been to turn the plane from a singular asset and transmogrify it into an asset class. This class, due to the sheer volume of capital involved, has begotten a burgeoning sale-leaseback industry and all of its affiliate components such as airframe rating agencies and appraisers. The UAF™ system takes the next step in the evolution of aviation finance by digitizing itself and its asset status.

In an embodiment, the UAF™ aircraft has a tokenized airframe. This simply means that the deeds of ownership are not held in weak and easily lost pieces of paper or files, but rather these deeds and proofs of ownership live on the blockchain. This tokenization chain will be operated in house and will not be a distributed ledger. Rather, for a desired rating of a desired airframe, the party in question must have ownership over said frame in order to have detailed access. In this way, only appropriate knowledge falls into appropriate hands while the entire chain is viewable for internal use by the company. A controlling entity may choose to provide information or fleet norms to all parties who have an aircraft so as to offer a point of comparison. However, the internal diagnostics from Corp A will never fall into the hands of Corp B.

In an embodiment, whereas now investment in airplanes is a prohibitive all or nothing ordeal, the tokenization of the airframe allows for fragmented trading in units of less than one. In this example, the UAF™ aircraft is represented by a singular token which in turn is fragmented into 1/10000ths (0.01%). Because of this fractional ownership, many smaller interested parties can pool for their own airframe that they co-own and co-operate as a collective. Additionally, for example, fragmented ownership upends the current stagnant ecosystem of giants and opens it to smaller players as well.

In an embodiment, the tokenization of the airframe allows the entire history record of the airframe to be inextricably tied to the deed as well. This Airframe Record will include all pertinent information that any appraiser would care about including things like part composition, quality checks, part replacement record, maintenance record (each instance), flight cycles record, flight cycle intensity record, anomalous flight instances (bird strike, lightning strike), and so on. This Airframe History can be compared across the fleet norms to subsequently generate a automatic rating report. While most rating agencies use an alphabetical triplicate to describe rating (AAA, BBB, CCC etc), we will use an internal metric set against a 0-100 scale. In an embodiment, this scale would take 100 to be a brandnew drone while 0 would be an irreparable one.

In an embodiment, new activities can also be conducted with tokenized airframes. Because the asset is dramatically more fungible, activities like futures trading and such can also be conducted more easily. Additionally, e.g., the sale-leaseback industry will catch a huge break, as will operators, as these deeds will be very easy to get on and off of books to accommodate appropriate scaling up and down based on economic forecasting.

Auth Chain.

In an embodiment, as shown in FIG. 15, the Authentication Chain is a critical blockchain in the parallel blockchain structure that operates on the UAF™ technology noded flight computer network. This chain expedites the bureaucratic processes and reduces border stresses in the operating procedure of the UAF™ technology. For example, some of the important authorizations provided by the chain are the regulatory compliance automation structures geared toward facil border crossing, air space utilization, airport booking authorization, air traffic control presence, and other governmental/authoritative body concerns.

In an embodiment, a benefit of using the blockchain is the reduction in error rate and purposeful fraud. Fraud is a major concern in the global supply chain, with IBM's blockchain division estimating that blockchain will provide a 40% reduction in the chronic maritime document fraud epidemic. As air freight booms in the coming decades, it will be critical to provide a secure and clean supply chain that can guarantee certified passage for certified goods, and nothing more. Debunking black market economics at the point of travel is a perfect interdiction that exemplifies blockchain implementation at its best. In terms of border security and national security for the United States of America, ensuring Customs and Border Patrol (CBP) is able to conduct their job quickly and effectively is to every party's utmost interest. In particular, maritime freight can experience tremendous delays even though it has already been disembarked and is in the United States proper. This comes from an inefficient system that involves backlogs of huge inspection queues. Some expedited programs do exist for partner nations I where CBP operates agents on the ground who conduct pre-inspection and pre-certification of certain containers. In this case, the CBP agent inspects and ISO compliant container and upon confirmation of acceptable cargo, seals the container with a physical seal on the locking mechanism.

Here, in an embodiment, the UAF™ technology would implement a virtual seal on its cargo. Once the shipping container is set in the receiving frame of the UAF™ aircraft, the CBP officer will interface with the UAF™ technology via a mobile device and can certify digitally with their signature that everything is compliant. At this point, the Auth Chain produces a new block that is set in the chain and is functionally set in digital stone. This authorization mechanism can then be instantly recognized by the CBP officials at the port of entry where they can expedite the movement of the UAF™ technology carried container upon arrival.

In an embodiment, another mechanism of the authorization chain will be the documentation management for functions of the Eco Chain in cases of government authorization and bookings management. While the Eco Chain can settle accounts, the Auth Chain can settle documentation. This is particularly key as noted above with CBP but also in the cases of trying to enter foreign airspace. Managing proper documentation on board the UAF™ aircraft will be key in minimizing ground system reliance and reducing infrastructure costs for the operating firms. Booking airport parking/docking spaces and managing special compliance for living cargo like horses are also document intensive processes that are best if automated by the UAF™ technology itself on the Authorization Chain rather than relying on a whole staff of administrative personnel.

The various embodiments of the software app described herein is a software application which is usable on a mobile device. This system provides for an expedient access to emergency contractor services and other contractor services, as well as a transparent process for selecting an appropriate contractor located nearby for a specific task. The software app can also be used from a computer terminal, or from a barebones tech device which connects to the network for all information and data. Embodiments of the present invention provide for computer-readable medium comprising computer-readable instructions which when implemented on a processing or computer device effects one or more actions. Embodiments of the present invention provide for one or more databases to hold the various information on the contractors, users, technicians, customers, and software system. The information can be stored in a single database or a distributed database structure, or in a variety of types of structured and unstructured locations. The information can be stored in a central server or on a variety of different servers or machines or processors. The information can be accessed by a mobile device using telecommunications, WiFi, or other communications protocols.

Features of the above-identified system and method can be combined with and without each other. While the above-described embodiments of the present disclosure are described in detail regarding specific displays, views, methods systems, the invention is not limited to thereto. Various equivalent variations or substitutions can be made by one or ordinary skill in the art without departing from the scope of the present disclosure, and are all included within the scope the disclosure of the present invention.

What is claimed is:

1. A system for transporting cargo, comprising:
an aircraft, the aircraft configured to fly by a remote control system, the aircraft having a top-side located door panel for receiving a container;
a computer processor, the computer processor configured to activate and control the remote control system of the aircraft; and
a docketing system, the docking system configured to load the container in the aircraft.
